(19) United States
(12) Patent Application Publication
(10) Pub. No.: US 2010/0068099 A1
(43) Pub. Date: Mar. 18, 2010

(54) LID

(75) Inventor: Johan Engström, Uppsala (SE)

Correspondence Address: FULBRIGHT & JAWORSKI, LLP, 1301 MCKINNEY, SUITE 5100, HOUSTON, TX, 77010-3095, US

(73) Assignee: GYROS Patent AB, Uppsala (SE)

(21) Appl. No.: 12/513,421

(22) PCT Filed: Nov. 8, 2007
(86) PCT No.: PCT/SE2007/050827

§ 371 Date: Sep. 18, 2009

Related U.S. Application Data
(60) Provisional application No. 60/865,071, filed on Nov. 9, 2006.

(30) Foreign Application Priority Data
Nov. 9, 2006 (SE) 0602384-0

(51) Int. Cl. B01L 3/00

(52) U.S. Cl. 422/102

(57) ABSTRACT

An aspect of the present invention includes a microfluidic assembly comprising: a planar substrate, a least a first surface of which has at least one open microchannel structure, a lid forming sheet material attached with a first surface to said first surface of said planar substrate, said lid forming sheet material is covering at least a portion of said at least one microchannel structure, wherein said lid forming sheet material has a first region with a first rigidity and a second region with a second rigidity. Other aspects of the present invention are reflected in the detailed description, figures and claims.

### TECHNICAL FIELD

The present invention relates to the production of microchannel and microcavity systems and to the microchannel and microcavity systems as such, and more particularly to an improved production method of a lid of a microfluidic disc and to the microfluidic disc comprising said improved lid.

### BACKGROUND OF THE INVENTION

Microchannel or microcavity structures are used inter alia chemical analytical techniques, such as electrophoresis and chromatography. A microfluidic device is defined as a device in which one or more liquid aliquots that contain reactants and have volumes in the μl-range are transported and processed in microchannel structures that have a depth and/or width that are/is in the μm-range. The μl-range is ≦1000 μl, such as ≦25 μl, and includes the nl-range that in turn includes the pl-range. The nl-range is ≦5000 nl, such as ≦1000 nl. The pl-range is ≦5000 pl, such as ≦1000 pl. The μm-range is ≦1000 μm, such as ≦500 μm.

A microfludic device typically contains a plurality of the microchannel structures described above, i.e. has two or more microchannel structures, such as 10, e.g. ≧25 or ≧90. The upper limit is typically ≦2000 structures.

Different principles may be utilized for transporting the liquid within a microchannel structure. Inertia force may be used, for instance by spinning the disc. Other useful forces are electrokinetic forces and non-electrokinetic forces other than centrifugal force, such as capillary forces, hydrostatic pressure, pressure created by one or more pumps etc.

The microfluidic device typically is in the form of a disc. The preferred formats have an axis of symmetry (Cₙ) that is perpendicular to or coincides with the disc plane, where n is an integer≧2, 3, 4 or 5, preferably ∞ (C_{∞}). The disc thus may have various polygonal forms such as rectangular. The preferred sizes and/or forms are similar to the conventional CD-format, e.g. sizes in the interval from 10% up to 300% of a circular disc with the conventional CD-radii (12 cm). If the microchannel structures are properly designed and oriented, spinning of the device about a spin axis that typically is perpendicular or parallel to the disc plane may create the necessary centrifugal force for causing parallel liquid transport within the structures. In the most obvious variants at the priority date, the spin axis coincides with the above-mentioned axis of symmetry.

In preferred microchannel structures, capillary force is used for introducing liquid through an inlet port up to a first capillary valve whereafter centrifugal force or some other non-passive driving means is applied for overcoming the resistance for liquid flow at the valve position. The same kind of forces/driving means is also used for overcoming capillary valves at other positions.

The microfluidic device may be circular and of the same dimension as a conventional CD (compact disc).

In order to facilitate efficient transport of liquid between different functional parts, inner surfaces of the parts should be wettable (hydrophilic), i.e. have a water contact angle ≦90°, preferably ≦60° such as ≦50° or ≦40° or ≦30°° or ≦20°. These wettability values apply for at least one, two, three or four of the inner walls of a microconduit. The wettability or hydrophilicity, in particular in inlet arrangements, should be adapted such that an aqueous liquid will be able to fill up an intended microcavity/microconduit by capillarity (self suction) once the liquid has started to enter the cavity/microconduit. A hydrophilic inner surface in a microchannel structure may comprise one or more local hydrophobic surface breaks (water contact angle≧90°. Such a break may wholly or partly define a passive/capillary valve, an anti-wicking means, a vent to ambient atmosphere etc. Contact angles refer to values at the temperature of use, typically +25° C., and are static. See WO 00056808, WO 01047637 and WO 02074438 (all Gyros AB).

Microchannels/micmcavities may be arranged on one side of a substrate and thereafter covered by a lid in order to create a closed microcavity, of course said microcavity and/or said microchannel may be provided with at least one inlet and at least one outlet. Said substrate may be of the same thickness as an ordinary compact disc, i.e., in the range of 1 mm. Said substrate may be regarded as semi flexible, i.e., the disc is bendable but do not change form if it is supported by different topologies. The lid may be regarded as flexible, i.e., if you put the lid on two different topologies the lid will take two different forms. It is advantageous to use a thicker substrate in which you may define the microchannels and on top of said substrate a flexible lid in form of a film, which may easily adapt itself to any curling and/or unevenness of the substrate that may be present. In this way you may increase the probability of attaching the lid to each and every portion of the substrate that one want to.

One problem with the microfluidic discs as disclosed above, is that when volumes are increased in the macrocavities and/or the pressure acting on the liquid in the microcavities are increased, there might be a risk that one or a plurality of the microcavities may start to leak.

### SUMMARY OF THE INVENTION

An object of the present invention is to eliminate or at least reduce the problem with leaking microfluidic disc in the design mentioned above.

The foregoing and other objects, apparent to the skilled man from the present disclosure, are met by the invention as claimed.

In a first example embodiment a microfluidic assembly comprising: a planar substrate, at least a first surface of which has at least one open microchannel structure, a lid forming sheet material attached with a first surface to said first surface of said planar substrate, said lid forming sheet material is covering at least a portion of said at least one microchannel structure, wherein said lid forming sheet material has a first region with a first rigidity and a second region with a second rigidity.

In another example embodiment said first region of said sheet material is located above said microchannel structure and said second region of said sheet material is positioned above the planar regions of said substrate.

In still another example embodiment said assembly is a rotatable disc.

In yet another example said first region of said sheet material is located at a first diameter and said second region of said sheet material is located at a second diameter.

In still another example embodiment said second rigidity is greater than said first rigidity.

In still another example embodiment said second region comprises at least one layer of material attached on top of a second surface opposite to said first surface of said lid forming sheet material.

In still another example embodiment said second region is cured.

In still another example embodiment said first region of said lid forming sheet material is thinner than said planar substrate.

In still another example embodiment said first region of said lid forming sheet material is thinner than ½ a thickness of said planar substrate.

In still another example embodiment said lid forming sheet material and/or said planar substrate is transparent.

In still another example embodiment said lid forming sheet material is attached to said planar substrate by means of hot glue.

Other aspects of the present invention are reflected in the detailed description, figures and claims.

### BRIEF DESCRIPTION OF THE DRAWINGS

FIG. 1a depicts a view from above of a first example embodiment of an improved lid according to the present invention.

FIG. 1b depicts a sectional view of the first example embodiment as depicted in FIG. 1a.

FIG. 2 depicts a view from above of a second example embodiment of an improved lid according to the present invention.

FIG. 3 depicts a sectional view of a third example embodiment of an improved lid according to the present invention.

FIG. 4 depicts a view from above of yet another example embodiment of an improved lid according to the present invention.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

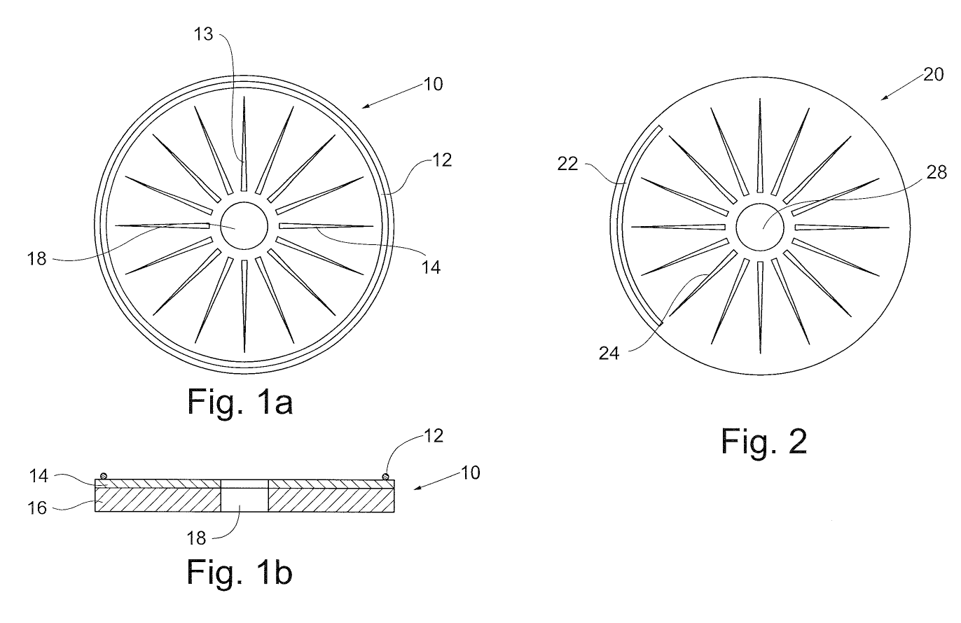

FIGS. 1a and 1b depicts an example embodiment of a microfluidic assembly 10 according to the present invention. Said assembly 10 comprises a substrate 16, a lid forming sheet material 14, central hole 18, a rigidity enhancing material 12, and microchannel 13.

The substrate may be made from different materials, such as plastics including elastomers, such as rubbers including silicone rubbers (for instance poly dimethyl siloxane) etc (Polymethyl methacrylate) PMMA, polycarbonate and other thermoplastic materials, i.e., plastic material based on monomers which comprises polymerisable carbon-carbon double or triple bonds and saturated branched straight or cyclic alkyl and/or alkylene groups. Typical examples are Zeonex™ and Zeonor™ from Nippon Zeon, Japan.

The substrate 16 and the lid forming sheet material 14 may be attached by means of bonding. The bonding material may be part of or separately applied to a surface of said substrate 16 and/or a surface of said lid forming sheet material 14. The bonding material may be the same plastic material as is present in the substrate 16, provided this plastic material can work as a bonding material. Other useful bonding materials are various kinds of adhesives, which fit to the material in the substrate 16 and the lid forming sheet material 14 and the intended use of the final device. Typical adhesives may be selected amongst melt-adhesives, and curing adhesives etc. Curing adhesives may be thermo-curing, moisture-curing, UV-curing and bi- three- and multi component adhesives.

The lid forming sheet material 14 may be manufactured by the same types of material as the substrate 16. This material is not critical as long as it is compatible with the adhesive heating principle etc. However, one may choose one type of material in the substrate 16 to be bonded with another type of material in the lid forming sheet material 14. The lid forming sheet material may be in the form of a laminated sheet and relatively thin compared to the substrate 16, which substrate 16 comprises the microchannel structures 13. In one embodiment the thickness of the lid forming material 14 is half a thickness of the substrate 16. In another embodiment the thickness of the lid forming material 14 is ¼ of the thickness of the substrate 16. In yet another embodiment the thickness of the lid forming material 14 is ⅛ of the thickness of the substrate 16. In one embodiment the thickness of the lid forming material 14 is 10% of the thickness of the substrate 16. The lid forming material may have a thickness range of 10 μm-2 mm, more preferably between 20 μm-400 μm. Different thickness ranges may apply to different materials in order to have a semi flexible lid forming sheet material. The substrate may have a thickness range of 100 μm-10 mm, more preferably between 400 μm-2 mm.

The shape of the microfluidic assembly is according to the example embodiments circular. However, any suitable form of said microfluidic assembly may be used, such as triangular, rectangular, octagonal, or polygonal.

In the example embodiment as illustrated in FIGS. 1a and 1b the rigidity enhancing material 12 is attached on top of the lid forming sheet material 14, i.e., on a opposite surface of said lid forming sheet material 14 to which is attached to said substrate 16. Said rigidity enhancing material 12 may be a curable glue of the same type as used to bond said lid forming sheet material 14 to said substrate 16. Said rigidity enhancing material 12 may also be a plastic material as used in the substrate 16 and/or said lid forming sheet material 14. The rigidity enhancing material 12 as exemplified in FIGS. 1a and 1b may be attached to the lid forming sheet material 14 by means of an adhesive. Said rigidity enhancing material 12 and said lid forming sheet material 14 may also be one single unit. The rigidity enhancing material 12 may be of a non-transmissive material such as metal, non-transmissive polymer, ceramic etc.

A cross section of the attached rigidity enhancing material may be of any shape, for instance circular or rectangular. A width of said rigidity enhancing material may range from 0.1 mm-5 mm and a height of said rigidity enhancing may range from 10 μm-2 mm.

The liquid flow may be driven by capillary forces, and/or centripetal force, pressure differences applied externally over a microchannel structure and also by other non-electrokinetic forces that are externally applied and cause transport of the liquid. Also electroendosmosis may be utilized for creating the liquid flow.

In the round form, the microchannel structures may be arranged radially with an intended flow direction from an inner application area radially towards the periphery of the disc. In this variant, the most practical way of driving the flow is by capillary action, centripetal force (spinning the disc).

The size of the disc may be the same as an ordinary CD.

The microchannels may have different sections with different characteristics such as hydrophobicity and hydrophilicity and different applications such as metering, volume defining sections, affinity binding sections and detections areas etc well known in the art.

A width and depth of microchannels and microcavities may vary along its structure, but a range between 10-100 μm is useful.

As depicted in FIG. 1a, said rigidity enhancing material 12 is located at a greater diameter than the microchannels 13.

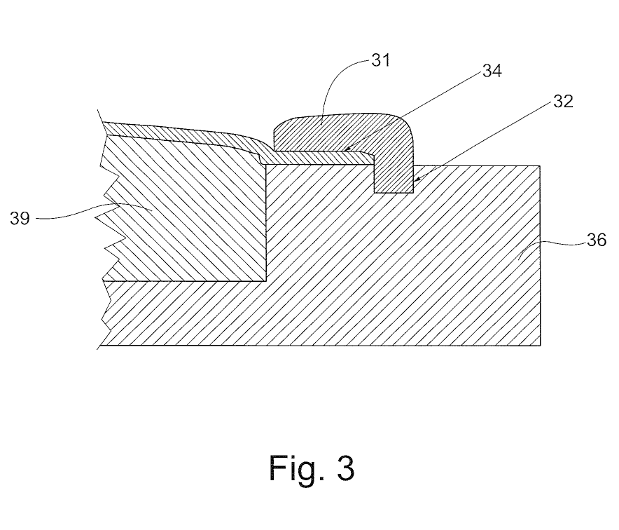

FIG. 3 illustrates a sectional view of a part of a microfluidic assembly. In this embodiment the substrate is denoted by 36, the microchannel by 39, the lid forming sheet material by 34 and said rigidity enhancing material by 31. In this embodiment one can see that the rigidity enhancing material 31 begins where the microchannel 39 ends. In this particular embodiment said rigidity enhancing material 31 is not only attached to the lid forming sheet material 34 but also to a recess 32 in the substrate 36. This is to further secure the rigidity enhancing material to the lid forming sheet when pressure is increased in the microchannel 39.

There might be a gap between the end of the microchannel and the beginning of the rigidity enhancing material. The size of such a gap may range between 0-1000 μm. In another embodiment said rigidity enhancing material is slightly overlapping the end of the microchannel. Said overlap may be in the range of 0-40% of the length in a radial direction of said microchannel/microcavity.

FIG. 2 illustrates that the rigidity enhancing material 22 may be formed only beyond some of the microchannels 24 in said microfluidic assembly 20 to prevent leakage of the microstructure out of the microfluidic assembly.

An alternative embodiment to a rigidity enhancing material is to have the lid forming sheet material cured beyond the microchannels. In this way there will be a first rigidity of the lid forming sheet material above the microchannels and another rigidity of the lid forming sheet material beyond the end of the microchannel. The degree of curing may be adjusted in order to match the thickness of the material and the material in the lid as such for best keeping the fluid in the microchannel without leaking. A curing may be homogenous through the thickness of the lid forming sheet material or only partly through said lid forming sheet material. A cross section of said cured area may have the same width and height ranges as defined for the attached rigidity enhanced material above.

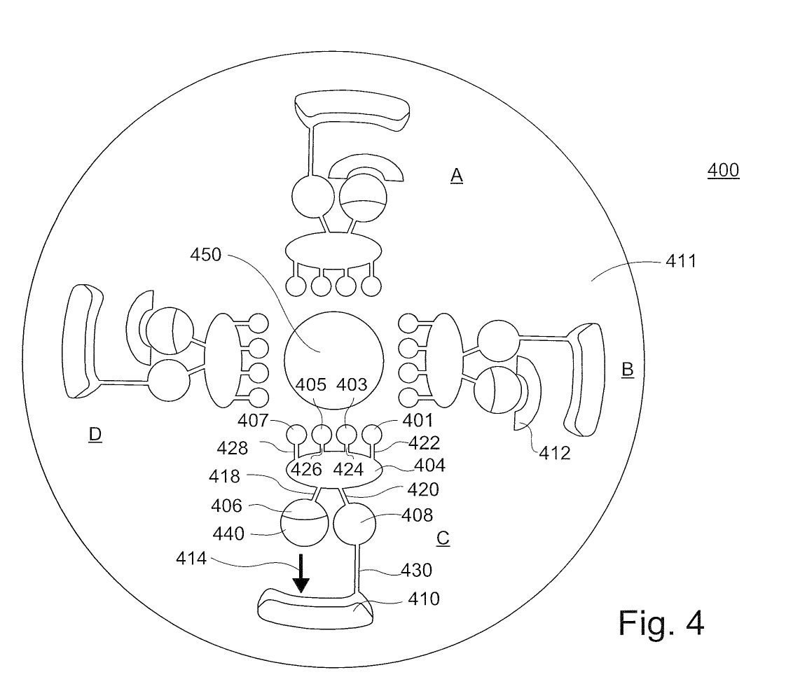

FIG. 4 illustrates yet another example embodiment of a microfluidic assembly 400 according to the present invention. This assembly 400 comprises a substrate 411 having four microfluidic structures A, B, C, D spaced at angular intervals around a central hole 450. Microfluidic structure C comprises a first, second, third and fourth fluid inlet denoted 401, 403, 405, and 407 respectively. The first fluid inlet 401 is connected to a first fluid cavity 404 via a first channel 422. The second fluid inlet 403 is connected to the first fluid cavity 404 via a second channel 424. The third fluid inlet 405 is connected to the first fluid cavity 404 via a third channel 426. The fourth fluid inlet 407 is connected to the first fluid cavity 404 via a third channel 428. Said first fluid cavity is connected to a second 406 and a third fluid 408 cavity via a fifth and sixth channel 418 and 420 respectively. Said third fluid cavity 408 is connected to a first fluid reservoir 410 via channel 430.

The microfluidic assembly 400 is as depicted in FIG. 4 circular and adapted for rotation about its central hole 450. The fluid inlets 401, 403, 405, 407 are in this embodiment arranged towards the central hole of the assembly 400. The Fluid reservoir is arranged towards the circumference of the assembly 400. Channels 422, 424, 426, 428, 418, 430 may be of suitable dimensions to enable capillary forces to act upon the fluid within the channel.

Hydrophobic valves may be arranged one or a plurality of the channels. Fluid may be fed into the inlet and will then be sucked down the channel by capillary action until it reaches the valve, past which it cannot flow until further energy is applied. This energy may for instance be provided by centrifugal force created by rotating the microfluidic assembly 400.

When RPM (Revolution Per Minute) of the microfluidic assembly is increased the pressure of the fluid acting upon surfaces of the second fluid cavity 406 is increased. At a certain RPM the pressure may be high enough for breaking the bonding of the lid forming sheet material to the substrate and thereby causing a leakage 414 from said second fluid cavity to said first fluid reservoir 410. Typical RPM ranges is 0-8000 RPM but higher RPM may be used such as 10 000, 15 000 or 20 000.

In order to prevent leakage from one part of the microfluidic structure to another part of the same structure or another structure a rigidity enhancing material 412 may be applied in a radial direction beyond said second fluid cavity 406. In FIG. 4 microfluidic sections A, B, and C has such a rigidity enhancing material 412 provided beyond said second fluid cavity 406 for preventing fluid 440 in cavity 406 to leak into for instance fluid reservoir 410 or any other microfluidic structure. The rigidity enhancing material 412 may have any shape and may suitable take the same shape as the cavity/chamber, reservoir, channel it is attached to. In FIG. 4, said second fluid cavity 406 may have the form of a sphere and said rigidity enhancing material has a shape which is adapted to a periphery of said cavity 406, i.e., in this case semi circular.

Rigidity enhancing materials may be provided in or on said lid forming sheet material covering the substrate, which substrate comprises one or a plurality of microchannels. Said rigidity forming material may prevent leakage from one part of a microfluidic structure to another structure or leakage from the microfluidic assembly as such, i.e., either leakage within the assembly or leakage from the assembly. The rigidity enhancing material is provided in the direction of fluid pressure. In case of spinning discs said rigidity enhancing material is provided in a radial direction beyond the structure it is to be prevented from leaking. In case of other fluid moving mechanism said rigidity enhancing material is applied where the fluid pressure is at highest. Said rigidity enhancing material may in another example embodiment be provided around the whole periphery of one or plurality of structures in the microfluidic assembly 400.

The microchannels and microcavities may be manufactures according to well known methods in the art, for instance according to a method which is illustrated in EP 1121234.

While the preceding examples are cast in terms of a method, devices and systems employing this method are easily understood. A magnetic memory containing a program capable of practicing the claimed method is one such device. A computer system having memory loaded with a program practicing the claimed method is another such device.

While the present invention is disclosed by reference to the preferred embodiments and examples detailed above, it is understood that these examples are intended in an illustrative rather than in a limiting sense. It is contemplated that modifications and combinations will readily occur to those skilled in the art, which modifications and combinations will be within the spirit of the invention and the scope of the following claims.

We claim as follows:

1. A microfluidic assembly comprising:
a planar substrate, a least a first surface of which has at least one open microchannel structure,
a lid forming sheet material attached with a first surface to said first surface of said planar substrate, said lid forming sheet material is covering at least a portion of said at least one microchannel structure, wherein said lid forming sheet material has a first region with a first rigidity and a second region with a second rigidity.

2. The microfluidic assembly according to claim 1, wherein said first region of said sheet material is located above said microchannel structure and said second region of said sheet material is positioned adjacent to the microchannel structures in said substrate.

3. The microfluidic assembly according to claim 2, wherein said assembly is a rotatable disc.

4. The microfluidic assembly according to claim 3, wherein said first region of said sheet material is located at a first diameter and said second region of said sheet material is located at a second diameter.

5. The microfluidic assembly according to claim 4, wherein said first diameter is smaller than said second diameter.

6. The microfluidic assembly according to claim 5, wherein said second rigidity is greater than said first rigidity.

7. The microfluidic assembly according to claim 6, wherein said second region comprises at least one layer of material attached on top of a second surface opposite to said first surface of said lid forming sheet material.

8. The microfluidic assembly according to claim 1, wherein said second region is cured.

9. The microfluidic assembly according to claim 1, wherein said first region of said lid forming sheet material is thinner than said planar substrate.

10. The microfluidic assembly according to claim 1, wherein said first region of said lid forming sheet material is thinner than ½ a thickness of said planar substrate.

11. The microfluidic assembly according to claim 1, wherein said first region of said lid forming sheet material is thinner than ¼ a thickness of said planar substrate.

12. The microfluidic assembly according to claim 1, wherein said first region of said lid forming sheet material is thinner than ⅛ a thickness of said planar substrate.

13. The microfluidic assembly according to claim 1, wherein said lid forming sheet material is made of a different material than said planar substrate.

14. The microfluidic assembly according to claim 1, wherein said lid forming sheet material and/or said planar substrate is transparent.

15. The microfluidic assembly according to claim 1, wherein said lid forming sheet material is attached to said planar substrate by means of hot glue.
